(19) United States
(12) Patent Application Publication
(10) Pub. No.: US 2013/0204800 A1
(43) Pub. Date: Aug. 8, 2013

(54) SINGLE STORE DIGITAL CERTIFICATE SYSTEM FOR BACKGROUND CHECK

(71) Applicants: Doug Adams, Brookline Station, MO (US); Jackie Dale Hursh, Springfield, MO (US)

(72) Inventors: Doug Adams, Brookline Station, MO (US); Jackie Dale Hursh, Springfield, MO (US)

(73) Assignee: BASS PRO INTELLECTUAL PROPERTY, L.L.C., Springfield, MO (US)

(21) Appl. No.: 13/365,947

(22) Filed: Feb. 3, 2012

(51) Int. Cl. G06Q 99/00

(52) U.S. Cl. 705/317

(57) ABSTRACT

System and method for complying with a firearm transfer regulation are presented. The system and method may determine, from a database containing information related to a firearm transfer, whether the firearm transfer needs a response from an electronic background check system. The system and method queries the electronic background check system for the response and receives the response from the electronic background check system. The system and method further generates a command to update the database with the received response. System and method may also include communicating information related to a firearm transaction to an electronic background check system that contains background check information. The information can be related to a transferee of the firearm transfer.

### BACKGROUND

1. Field

Embodiments generally relate to a system for facilitating transfer of firearm, and more specifically for complying with regulations of such a transfer.

2. Description of Related Art

Federal regulations require firearm sales by a licensed store, dealer, or other federal firearm licensee (FFL) to be recorded in a Firearm Transaction Record Part I, also called Form 4473, which must be kept on file for 20 years and made available for any audits by the Bureau of Alcohol, Tobacco, and Firearm (ATF). To complete Form 4473, it must be submitted to the National Instant Criminal Background Check System (NICS), which determines whether the sale complies with certain laws. Store personnel submitting the form has to call a NICS phone bank and verbally relay pieces of information from the form to an operator, or has to type the pieces of information to a web form on the NICS website. An improved, faster, automated system and method for complying with firearm transfer regulations is needed.

### SUMMARY OF THE INVENTION

One embodiment of this invention relates to a method for complying with a firearm transfer regulation, including determining, from a database containing information related to a firearm transfer, whether the firearm transfer needs a response from an electronic background check system. The method further includes querying the electronic background check system for the response and receiving the response from the electronic background check system. The method further includes updating the database with the received response.

One embodiment of this invention relates a method for complying with a firearm transfer regulation, including determining, from a database containing information related to a firearm transfer, whether the contained information related to the firearm transfer is complete for a background check. The method further includes communicating at least part of the information related to the firearm transfer to an electronic background check system containing background check information if the contained information related to the firearm transfer is complete. The at least part of the information includes information related to a transferee of the firearm transfer.

In some embodiments, querying the electronic background check system comprises communicating with a website server of the electronic background check system. In some embodiments, the website server of the electronic background check server is a National Instant Criminal Background Check System website server. In some embodiments, the electronic background check system comprises a background check database.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In addition, it should be appreciated that structural features shown or described in any one embodiment herein can be used in other embodiments as well. As used in the specification and in the claims, the singular form of “a”, “an”, and “the” include plural referents unless the context clearly dictates otherwise. The term “may” as used herein is used in the permissive sense, and indicates that various structures, functions, and features disclosed herein can and will optionally be used depending upon the specific embodiment.

### BRIEF DESCRIPTION OF THE DRAWINGS

FIG. 1 illustrates a computing environment that includes a system for ensuring legal compliance in a firearm transaction, in accordance with an embodiment herein.

FIG. 2 is a flow diagram that illustrates a method for managing regulatory compliance in a firearm transaction, in accordance with an embodiment herein.

FIG. 3 is a flow diagram that illustrates a method for managing forms related to regulatory compliance for a firearm transaction, in accordance with an embodiment herein.

FIG. 4 is a flow diagram that illustrates a method for managing information related to regulatory compliance for a firearm transaction, in accordance with an embodiment herein.

FIG. 5A is a flow diagram that illustrates a method for collecting information for a firearm transaction, in accordance with an embodiment herein.

FIG. 5B is a flow diagram that illustrates a method for collecting information for a firearm transaction, in accordance with an embodiment herein.

FIG. 5C is a flow diagram that illustrates a method for collecting information for a firearm transaction, in accordance with an embodiment herein.

FIG. 5D is a flow diagram that illustrates a method for collecting information for a firearm transaction, in accordance with an embodiment herein.

FIG. 6A is a flow diagram that illustrates a method for obtaining an electronic background check for a firearm transaction, in accordance with an embodiment herein.

FIG. 6B is a flow diagram that illustrates a method for obtaining an electronic background check for a firearm transaction, in accordance with an embodiment herein.

FIG. 6C is a flow diagram that illustrates a method for obtaining an electronic background check for a firearm transaction, in accordance with an embodiment herein.

### DETAILED DESCRIPTION

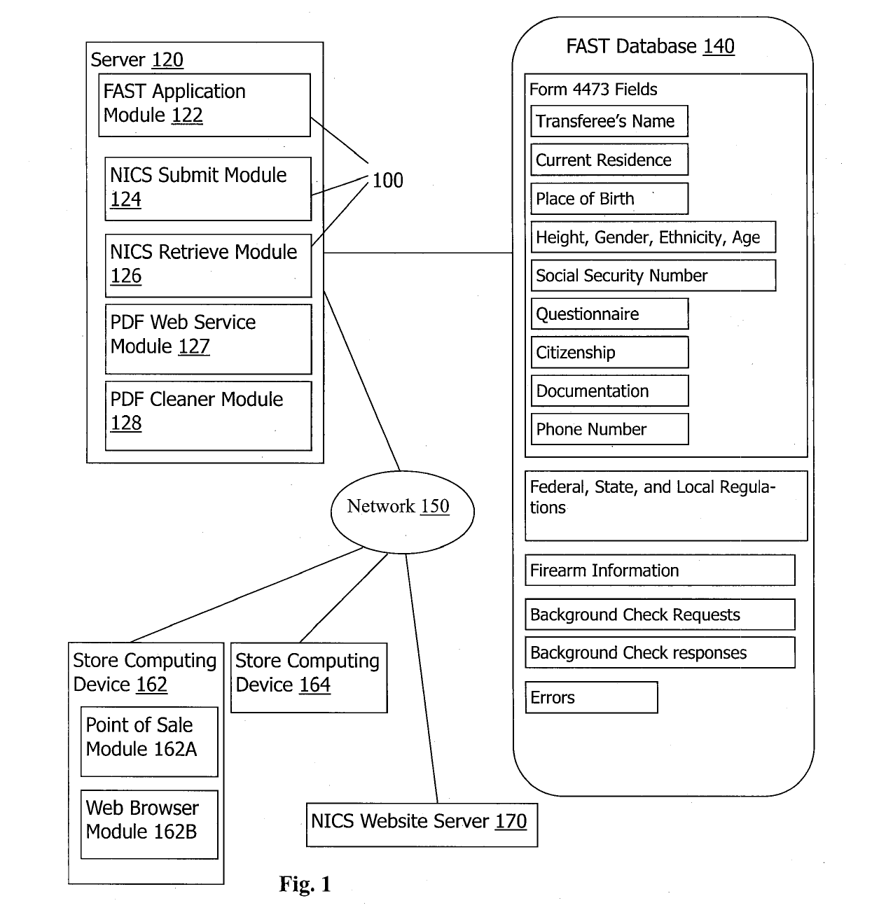

FIG. 1 shows a system 100 that may facilitate regulatory compliance for a Federal Firearm Licensee (FFL) or any other transferor of firearm. A FFL, which may include one or more firearm stores, need to comply with regulations such as the federal Gun Control Act, which requires firearm sales and other transactions to be recorded and to pass a background check. Firearm transactions may be recorded in, for example, a Firearm Transaction Record Part I (OMB No. 1140-0020), also known as Form 4473. A background check on a firearm transferee and on other aspects of the firearm transaction may be conducted through, for example, the FBI's National Instant Criminal Background System (NICS). NICS may respond with a background check result of, for example, “Proceed,” “Denied,” “Cancelled,” or “Delayed.” The result may be recorded in the form 4473 or in any other form. System 100 may facilitate collecting information for a form such as the form 4473, recording the information, and obtaining a background check for a firearm transaction.

System 100 may be part of a computing environment 10 with components communicating over network 150, which may be a local area network (LAN) or the Internet. Computing environment 10 includes one or more client devices, such as store computing devices 162 and 164, and one or more servers, such as server 120, that communicates with the client devices via network 150. Computing environment 10 further includes one or more databases, such as a firearm systems transfer (FAST) database 140, that communicates with server 120. Environment 10 further includes an electronic background check system, such as the National Instant Criminal Background Check System (NICS), which may be able to communicate with server 120 and the client devices through network 150. NICS may have a NICS website server 170 that provides a communication interface to server 120, to client devices 162 and 164, or to any combination thereof.

The client devices such as store computing devices 162 and 164 may be located at one or more FFL retail locations, such as one or more firearm stores. Each client device may be operated by a user, such as a sales associate, a manager, other FFL personnel, or a customer to input information about a firearm sale or other transfer. In one embodiment, a client device such as store computing device 162 is configured to execute a point of sale module 162A, which may be configured to authenticate a user. For example, module 162A may ensure that only FFL personnel can initiate a firearm sale or that only a firearm manager can use the module to manage store associates. Module 162A may grant different levels of access to a user based on whether the user is authenticated as a firearm manager, a firearm lead, or a firearm user.

In one embodiment, a client device such as device 162 executes a web browser module 162B. Module 162B may be configured to communicate with a web server or other computing device over a network. For example, module 162B may be configured to implement a network communication protocol such as HTTP, HTTPS, FTP, FTPS, SSHFTP, or any other communication protocol. In one embodiment, device 162 is configured to communicate over network 150 directly with point of sale module 162A. Each client device may be a desktop computer, laptop, tablet, mobile device, or any other computing device adapted to collect and/or communicate information related to a transfer of firearm.

Server 120 is configured to receive information related to firearm transactions from client devices such as store computing devices 162 and 164. In one embodiment, server 120 comprises one or more processors configured to execute a FAST Application module 122, NICS submit module 124, NICS retrieve module 126, PDF web service module 127, and PDF cleaner module 128. The modules may be executed on one server, such as shown in FIG. 1, or on multiple servers.

FAST application module 122 facilitates recording of a firearm transaction. In one embodiment, module 122 interacts with client devices such as store computing devices 162 and 164 to collect information related to the firearm transaction. FAST application module 122 may, for example, implement a web application that communicates information (e.g., commands or data) with a web browser module on each client device. For example, module 122 may generate and transmit a form 4473 question or field to an instance of Internet Explorer or Firefox running on store computing device 162, which may present the question or field to a user such as a FFL personnel or customer. Module 122 may receive a response to the question or field and may record the response in a database such as FAST database 140. Module 122 may facilitate accuracy of a firearm transaction record by automatically retrieving firearm information, checking whether information entered by a user is within a valid range, and whether the user skipped entering of any information. Module 122 may facilitate regulatory compliance by checking whether local, state, or federal law prohibits the firearm transaction. Module 122 may facilitate enforcement of the FFL's own practice, such as encryption of customer data or collection of the customer's phone number. FAST application module 122 may be part of a firearm transaction recording system of system 100.

NICS submit module 124 and NICS retrieve module 126 facilitate conducting of a background check necessary for some firearm transactions. In one embodiment, modules 124 and 126 interact with an electronic background check system such as the National Instant Criminal Background Check System (NICS). NICS submit module 124 may be configured to retrieve information on a transferee or on other aspects of a firearm transaction from a database and submit the information to the electronic background check system. NICS retrieve module 126 may be configured to query the electronic background check system for a response, such as a result of whether the transaction passed or failed a background check. For example, NICS retrieve module 126 may query the database to determine which firearm transactions are waiting for a response from the electronic background check system, and then query the background check system for a response associated with the firearm transactions. In one embodiment, modules 124 and 126 may be configured to communicate with a server of the electronic background check system through a platform such as Ajax. In one embodiment, execution of modules 124 and 126 may be triggered by FAST application module 122, such as after module 122 has collected information necessary for a background check. In one embodiment, modules 124 and 126 may be executed in a manner that is asynchronous with execution of FAST application module 122. In the embodiment, FAST application module 122 may submit a background check request to database 140, and modules 124 and 126 may poll database 140 to detect the background check request, submit the request to the electronic background check system, and update database 140 with a response from the system. The modules may update database 140 by generating a command to update the database with the response. If database 140 were stored on one or more servers that are separate from server 120, the command may be transmitted from server 120 to the one or more servers.

The modules remove a need to manually type transaction information on a NICS website or to manually call a NICS phone bank, and instead may automatically submit requests for and retrieve responses to background checks. The modules may thus reduce the time needed to obtain a background check result from NICS and reduce the possibility of user error arising from manual entry of information. Modules 124 and 126 may be part of a background check monitoring system of system 100.

PDF Web Service module 127 facilitates generating a PDF version of a firearm transaction record. For example, module 127 may generate a PDF version of a form 4473, which a client device can download and print. In one embodiment, module 127 may be configured to retrieve firearm transaction information from database 140. If the firearm transaction information from database 140 is not indexed by fields of the form 4473, module 127 may be configured to populate the fields by locating one or more portions of the transaction information that correspond to a field of the form 4473. Although generation of a PDF file is discussed here, server 120 may be configured to generate other document formats in this or another embodiment. The other document formats include a Crystal Report format, an image file format, or any other document presentation format.

PDF cleaner module 128 facilitates removing old PDF files (e.g., older than five days) such as files generated by module 127. The old PDF files may no longer be needed, and module 128 may free disk space by removing the files. In one embodiment, module 128 may be configured to run once a day, at a time at which server 120 is determined to be most idle.

FAST database 140 stores information related to firearm transactions. The database may be stored on server 120 or on a different server or servers. In one embodiment, FAST database 140 stores information related to a customer or any other transferee of a firearm transaction, such as the transferee's name, residence, place of birth, height, gender, ethnicity, age, social security number, citizenship, phone number, documentation type (e.g., driver's license) and number, and answers to any questionnaires related to criminal background, drug abuse, or other questions required by the FFL or by law. In one embodiment, database 140 stores information related to one or more firearms that were sold, such as firearm type, SKU, manufacturer, serial number, model, caliber, and gauge. In one embodiment, database 140 may store information related to firearms regulations, such as local, state, and federal laws. In one embodiment, database 140 may store information related to background checks, such as information related to which firearm transaction or transactions are requesting a background check and information related to a response to the request. In one embodiment, information on database 140 may be encrypted. The information may be first encrypted by FAST application module 122 and submitted to database 140, or may be encrypted an application managing database 140. In one embodiment, information related to errors in processing a firearm transaction may be stored on database 140.

In one embodiment, an overrides database table may be stored as part of database 140 or may be stored separately. The overrides database table may allow a user to add variations to firearm transfer regulations. For example, a general state regulation may be stored on database 140 indicating that each store of the FFL may sell a handgun to only residents of that store's state. An exception to the general regulation may be added for Tennessee regulations, which allows a store in Tennessee to sell a handgun to an active duty military personnel living on base in Fort Campbell, Ky. if the personnel declare him or herself to be a resident of Tennessee. The overrides database table may be indexed by, for example, a form 4473 field that is affected by the variation, by a state, county, or city of the transferee, a state, county, or city in which a FFL store is located, on a firearm type affected by the variation, or a customer type (e.g., active duty military, alien, non-immigrant alien) affected by the variation. The overrides database table may be checked by FAST application module 122 or by database 140 to determine whether a firearm transaction complies with firearm transfer regulations.

In one embodiment, an OtherID rules table may be stored as part of database 140 or may be stored separately. The OtherID rules table may allow a user to add variations to what identification is needed to transfer a firearm. For example, a general state regulation may be stored on database 140 indicating that a firearm owner's ID (FOID) can be used as only secondary identification, not as primary identification. An exception may be added to the OtherID rules table indicating that Illinois permits a FOLD to be used as a primary identification. The OtherID rules table may be checked by FAST application module or by database 140 to determine whether information being collected for a transaction satisfies regulations.

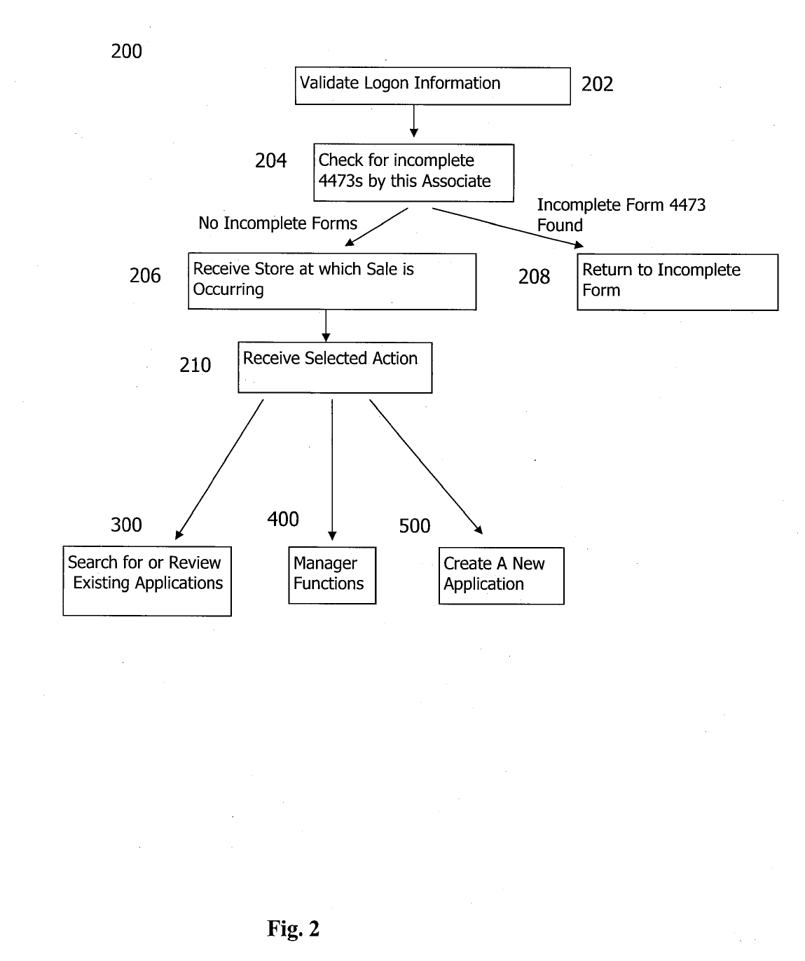

FIG. 2 illustrates a method 200 for collecting and managing information related to the transfer of firearm. Such information may be recorded on a Form 4473 and may be used to conduct a required background check on the customer. One or more operations of method 200 may be implemented by system 100, by any other computing system of any other computing environment, or any combination thereof.

At operation 202, login information may be received from a client device. The login information may ensure that only authorized FFL personnel or subscribers can access services provided by method 200. In one embodiment, login information may be received by FAST application module 122 running on server 120 from a module such as point of sale module 162A of device 162. Module 162A may have already collected login information to authenticate a user. In one embodiment, a message prompting a user to enter login information may be outputted to store computing device 162, which may present the message with, for example, web browser module 162B (outputting information or a command may include generating or retrieving the information or command and transmitting the information or command to a client device through a network; the client device may then execute the command or present the information to a user). Login information may include a password, biometric authentication information, a security question, or any combination thereof. The received login information may be verified against valid login information stored in a database, such as a point of sale (POS) database. Operation 202 may grant different levels of access based on the login information. In one embodiment, at least three different levels, based on whether the login information belongs to a firearm user, a firearm lead, or a firearm manager, is granted. In one embodiment, operation 202 may authorize a login attempt from a client device only if no other client device is logged on with the same login information at the same time.

A user who has logged in may begin a new firearm transaction or may resume one that he or she had previously begun. A previously begun transaction may need to be resumed because the user had logged off from an application for processing the transaction, such as FAST application module 122, or because a client device interfacing with the application may have experienced an error during a previous application session. At operation 204, a search for any incomplete records from any incomplete firearm transactions may be performed. For example, if an incomplete form 4473 is found, a user may be returned to a webpage or other interface to resume a firearm transaction associated with that form 4473. The point at which to resume the transaction may be determined from what fields of the form 4473 remain to be completed. In one embodiment, if the user is a store sales associate, the search may present only transactions begun by that sales associate, while if the user is a store manager, the search may present transactions begun by all FFL personnel at that store.

At operation 208, any incomplete records, such as an incomplete form 4473, may be outputted on a client device so that the user can resume the firearm transaction. In one embodiment, any incomplete records may be retrieved by FAST application module 122 from a POS database or from FAST database 140.

If no incomplete records are found at operation 204, a user may be prompted to select a store, at operation 206, before selecting further actions related to firearm transactions. For example, FAST application module 122 may output a list of FFL stores on a client device along with instructions prompting the user to select a FFL store at which he or she works. In one embodiment, only certain FFL stores are outputted to the user for selection, or only certain selections are accepted as valid. For example, if FAST application module is configured to determine a location from which the user is accessing system 100, it may output for selection only FFL stores at or near the location, or accept only such stores as valid selections. Limiting selection of a FFL store may limit access to information associated with the FFL store. In one embodiment, the limitation may be based on other factors. In one embodiment, after the user's selection is received, such as by module 122, it is used to complete a record, such as a FFL ID field of a Form 4473, or to request a background check for a firearm transaction.

At operation 210, a user's selection for other actions related to a firearm transactions may be received. A user may be presented with options to execute a method 300 to search for completed forms, a method 400 to execute a manager function, or a method 500 for initiating a new firearm transaction and creating a new record associated with the transaction. The user's selection may be received by an application such as FAST application module 122.

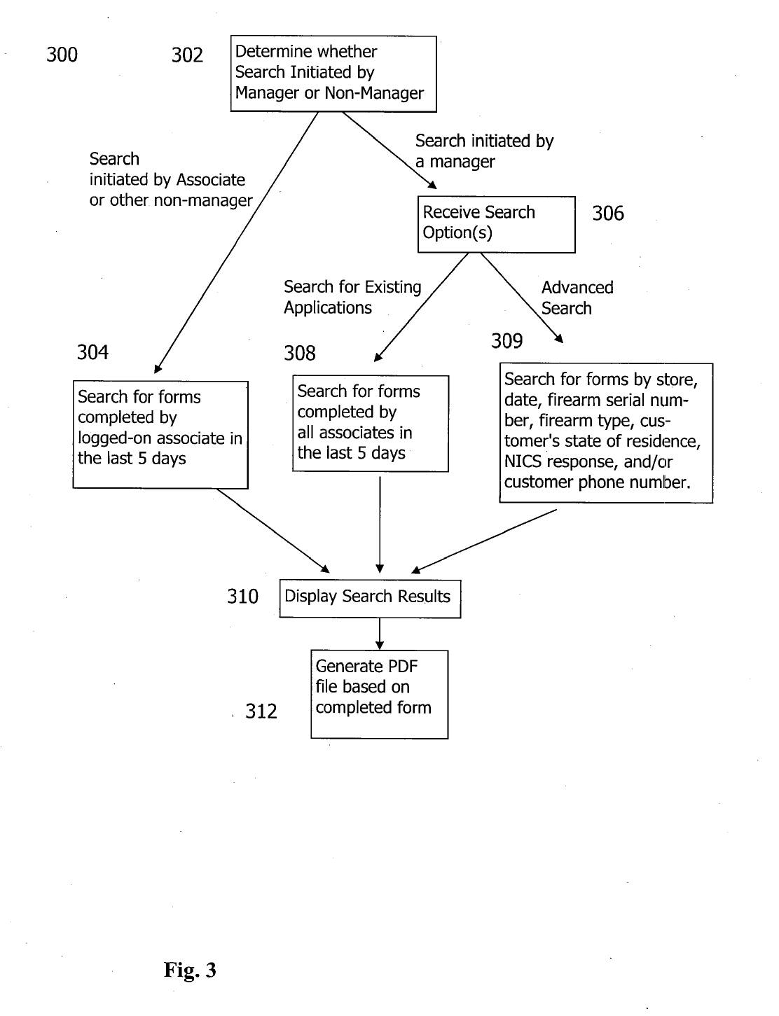

FIG. 3 shows example operations of a method 300 for managing existing records of firearm transactions, such as completed form 4473's. At operation 302, whether a search is being initiated by a manager or a non-manager is determined. A sales associate or any other user who is a non-manager may be allowed to search for only records completed by that user.

If the user is a non-manager, a search for records completed by the user in the last five days may be performed at operation 304. The search may be performed by, for example, FAST application module 122, which may retrieve completed forms from a database such as FAST database 140. In other embodiments, the search is not limited to forms in the last five days, but may be performed for any time frame, such as within the last week, month, year, or at any time.

If the user is a manager, a search for records completed by all users, such as all sales associate at a FFL store or all personnel at multiple FFL stores, may be performed. At operation 306, a selection from the manager user for performing a basic search or for performing an advanced search may be received. If the manager user selects a basic search, a search for all forms completed by all sales associate at the manager user's store, for example, may be performed. If the manager user selects an advanced search, form fields that allow a user to narrow a search may be outputted. For example, form fields for entering a store, date, firearm serial number, firearm type, customer's residence, background check response, and/or customer phone number associated with a transaction record may be outputted. A manager user's entry may be received by, for example, FAST application module 122, which may query FAST database 140 for a firearm transaction having the entered criteria.

At operation 310, search results may be communicated to a client device of the user. In one embodiment, the results may be sorted chronologically or based on a search criteria entered by a manager user. At operation 312, one or more completed forms may be converted to an electronic document format such as a portable document file (PDF), such as by PDF web service module 127. Instructions or requirements related to the transaction, such as on a waiting period or a customer residency requirement, may be included in the electronic document. The completed form may be outputted in the electronic format to the client device, which may print the form so that it can be signed by a customer and/or archived. In one embodiment, a message may be outputted along with the PDF file asking a user to respond with a confirmation that a transaction identification, such as a serial number, on the printed PDF file is correct. One or more operations of method 300 may be executed by an application facilitating firearm transactions, such as by FAST Application module 122.

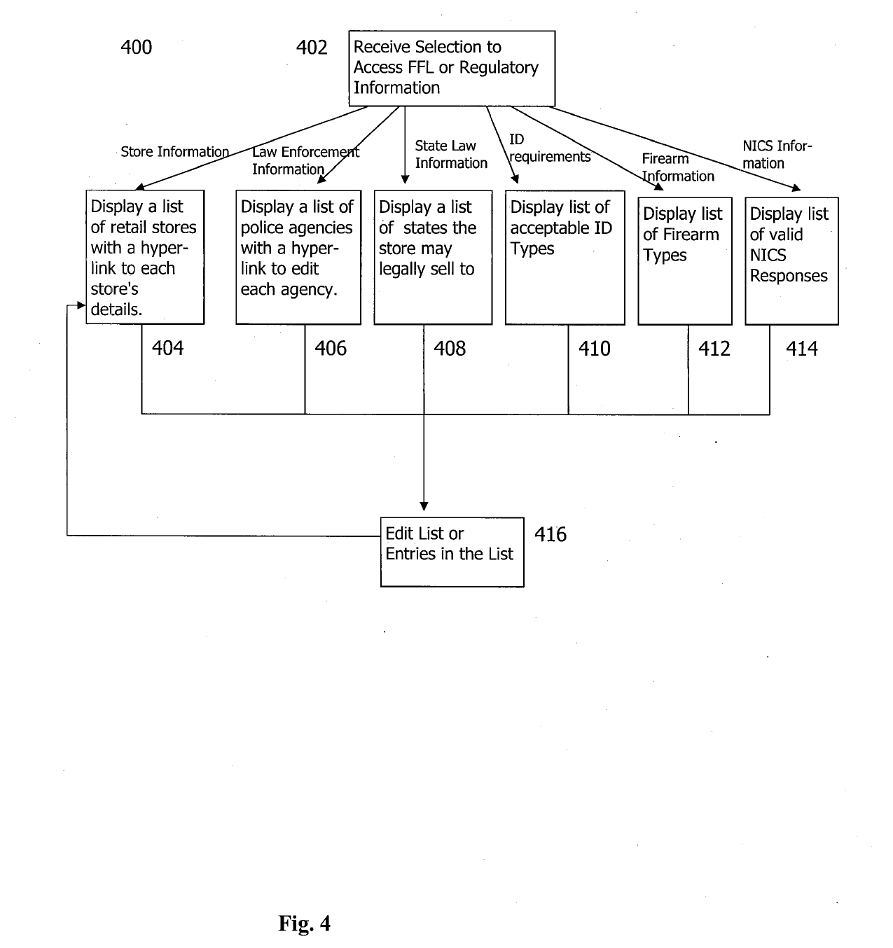

FIG. 4 shows example operations of a method 400 for executing manager functions. A request to execute a specific manager function may be received at operation 402. The request may be received, for example, by FAST application module 122 from a client device operated by a manager user. Manager functions may include viewing or editing information relating to stores of a FFL, to firearm transfer regulations, to firearms, and to law enforcement agencies. The information may be retrieved by, for example, module 122 from a database such as FAST database 140, the override database table, the OtherID rules table, or any combination thereof. Additions, editing, or deletion of the information may be reflected in the FAST database 140, override database table, OtherID rules table, or any combination thereof.

At operation 404, a list of retail or other stores of the FFL along with a hyperlink to each store's full details may be outputted. Outputting the list may include generating or retrieving the list and transmitting the list to a client device, which may present the list. A FFL store's full details may include the store's FFL ID number and address. At operation 416, a user entry may be received to add a new FFL store to the list, to edit information of a current FFL store in the list, or to delete a FFL store from the list.

At operation 406, a list of police and other law enforcement agencies along with a hyperlink to each agency's full details may be outputted. An agency's full details may include the agency's name and address. At operation 416, a user entry may be received to add a new agency to the list, to edit information of a current agency in the list, or to delete an agency from the list.

At operation 408, a list of states to which a FFL store may sell firearms may be outputted. For example, state law for a firearm store in that state may permit handgun sales or other transfers to only residents of that state. The state law may permit long gun sales or other transfers to only residents of that state and residents of adjacent states. Operation 408 may include receiving a user entry of a state in which the FFL store is located and retrieving information related to which states the store may transfer a firearm. The information retrieved may include a list of specific states, or may more generally include firearm transfer laws of that state and federal firearm transfer laws. If the firearm transfer regulations are retrieved, operation 408 may include other required criteria for a customer in a firearm transaction. For example, a reminder may be generated that regulations in the store's state requires a customer to be 18 or older to purchase any type of firearm and to be 21 or older to purchase a handgun. At operation 416, a state may be added to or removed from the list of states to which a FFL store may transfer firearm. Qualifications may be included with an addition of a state. For example, the list of states to which a store in Tennessee may sell a handgun may be updated to include Kentucky, but with the qualification that a customer from Kentucky must be an active duty military personnel living on base in Fort Campbell, Ky. The list of states and/or firearm transaction regulations may be retrieved and updated by, for example, FAST application module 122 from and to FAST database 140, Overrides database table, or any combination thereof.

At operation 410, a list of acceptable ID types for a firearm transaction may be outputted. For example, the list can indicate that acceptable ID's for a firearm sale include a state ID (such as a driver's license, concealed carrying permit, Firearm Owners Identification (FOID) card), a military ID (such as a military-issued ID, Permanent Change of Station (PCS) orders) or an alien ID (such as a state hunting license, letter from U.S. Attorney General). At operation 416, a user entry may be received to add an ID type or sub-type to the list, edit an ID type or sub-type in the list, or delete an ID type or sub-type from the list. For example, the FOID type may be edited to indicate that it can be used as a primary identification in Illinois and can be used as only a secondary identification in all other states.

At operation 412, a list of firearm types may be outputted. In one embodiment, the list may indicate that the FFL's inventory includes pistols, revolvers, rifles, or shotguns, and may indicate whether the firearm types belong to a handgun classification or a long gun classification. The information in the list may be used to identify in a Form 4473 (e.g., field 18) what type of firearm was sold or otherwise transferred. At operation 416, a user entry may be received to add a firearm type to the list, edit a firearm type in the list, or remove a firearm type from the list.

At operation 414, a list of valid background check results, such as NICS responses, may be outputted. For example, if background checks are being requested from NICS, the list may indicate that the only valid responses from NICS are “Proceed,” “Denied,” “Cancelled,” and “Delayed.” In one embodiment, the list of valid responses may be stored in FAST database 140 and may be retrieved by FAST application module 122. Module 122 may use the list to determine, for example, whether a valid background check response has been received or whether the background check has experienced an error. At operation 416, a user entry may be received to add a valid response to the list, edit a valid response in the list, or remove a valid response from the list.

The information in the lists discussed above may be stored in FAST database 140. FAST database 140 may store other information used to complete a record of a firearm transaction. For example, database 140 may store a list of valid cities, counties, and states; a valid range for personal characteristics such as age, height, or weight; a list of ethnicities, and a list of valid last name suffixes. In one embodiment, the cities, counties, and states may be linked in the database to ensure that a city selected by a user is in a county selected by the user and that the selected county is in a state selected by the user. The above lists may also be edited. The values stored in database 140 may facilitate error-checking when the record of the firearm transaction is being completed.

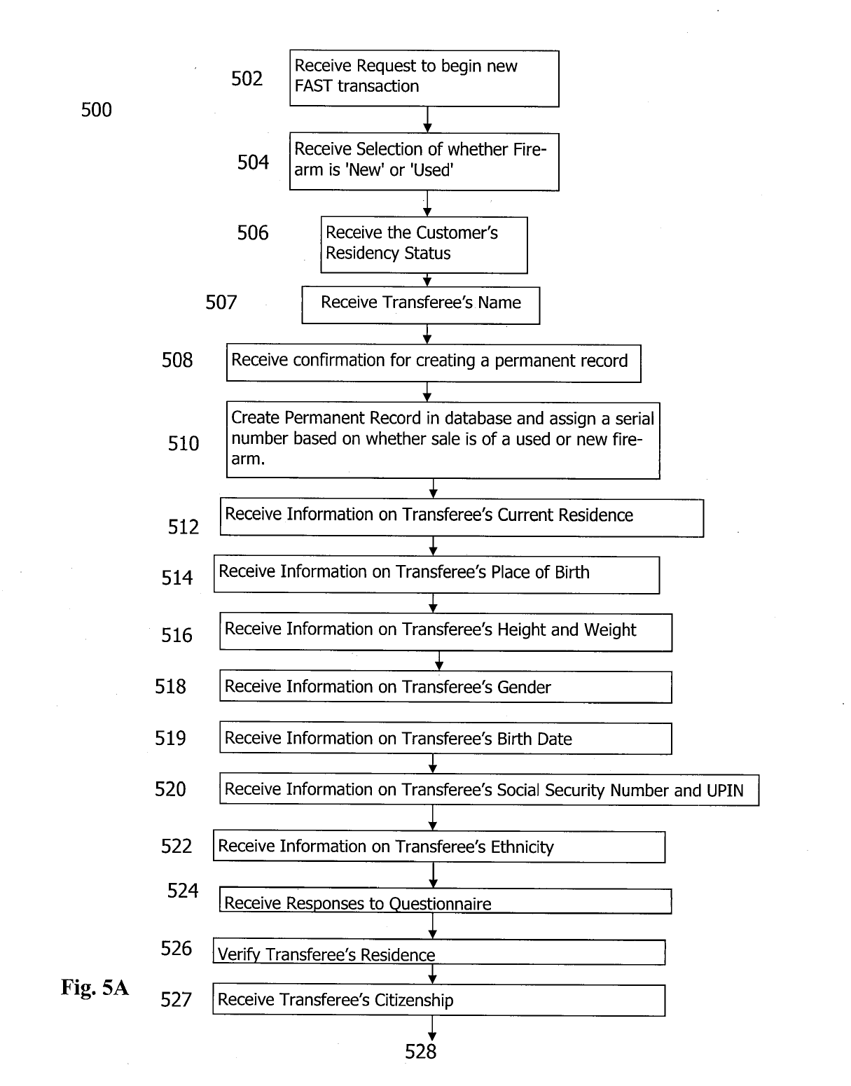

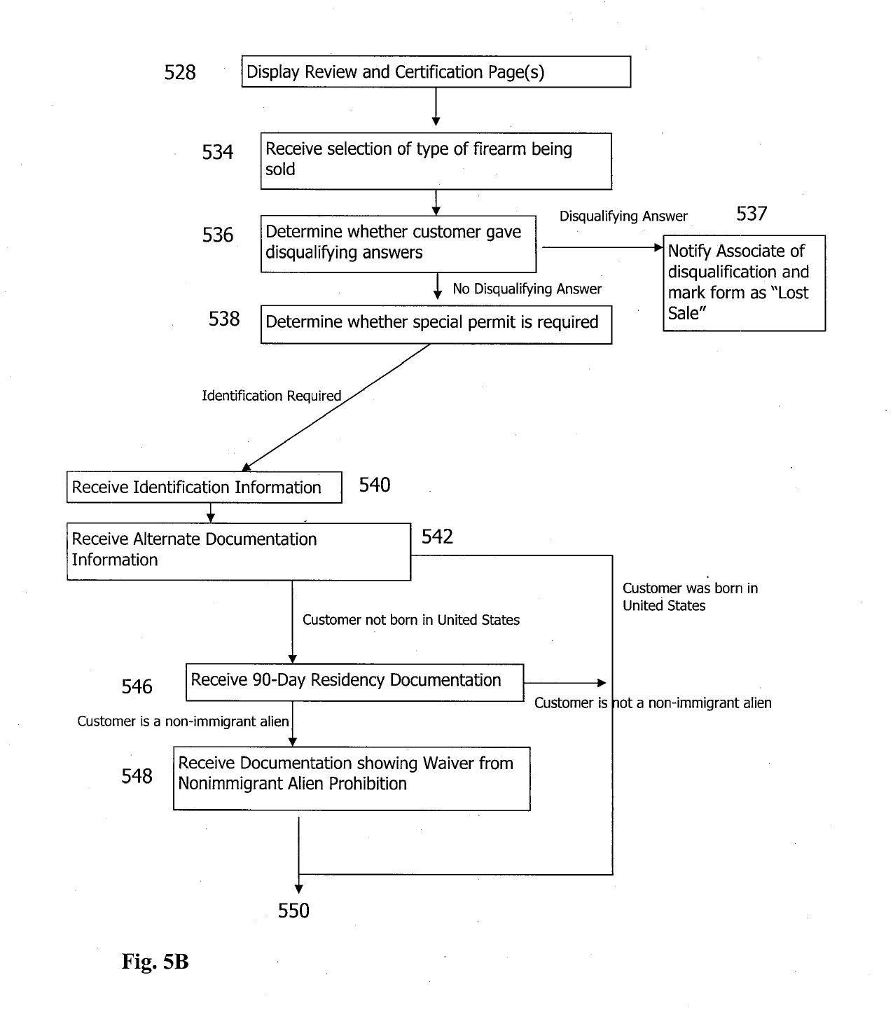

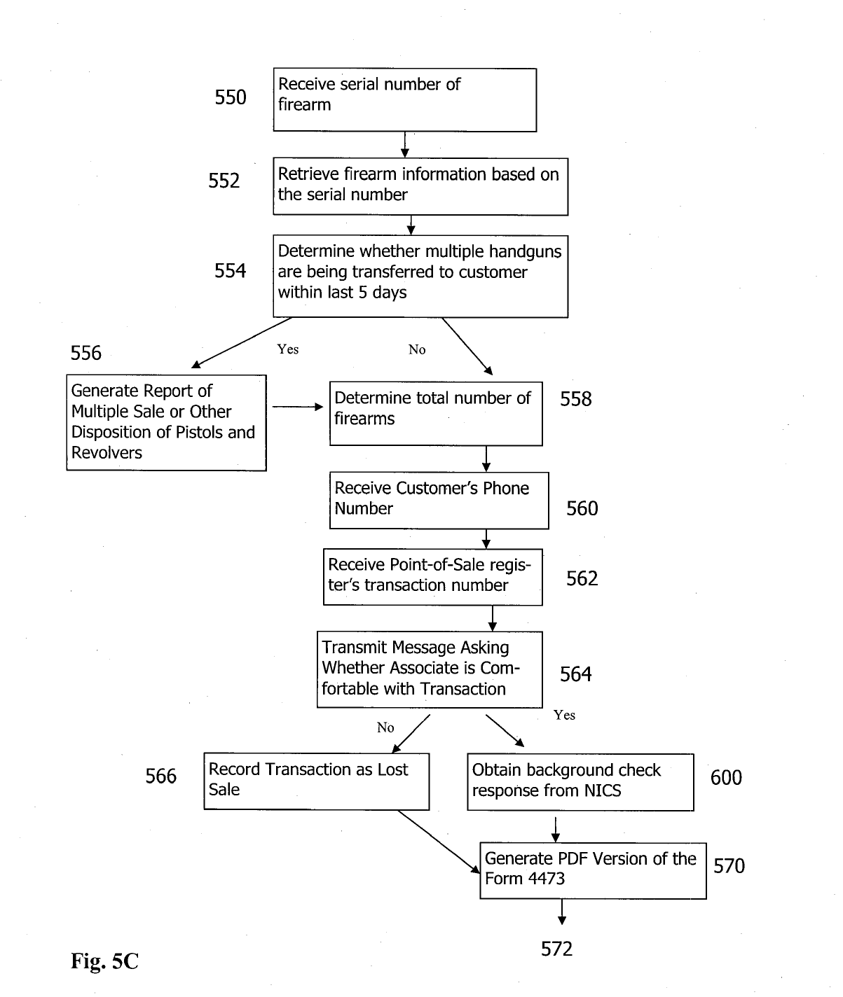

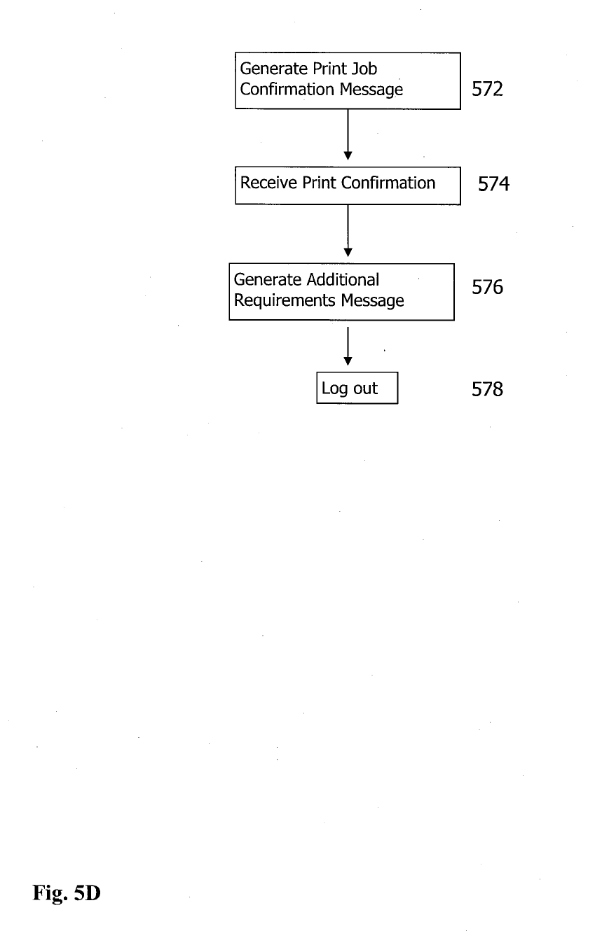

FIG. 5A-5D illustrate example operations of a method 500 for initiating a new record for a new firearm transaction. In one embodiment, the operations may be executed by FAST application module 122, and information in the record may be stored in FAST database 140. Operations of method 500 may collect information and any certifications necessary to comply with policies of the FFL and with local, state, and federal firearm transaction regulations. The operations may output instructions and form fields (e.g., text boxes, radio buttons, check boxes, drop down lists) to a client device and receive information from a user in response. In one embodiment, the operations may cause the client device to present the instructions and form fields on multiple webpages of a web browser. In the embodiment, if a user attempts to go back to previous webpage, whether the information in the previous webpage can be modified may be determined. For example, if a user attempts to go back to a webpage where a transferee's last name was entered, it may be determined that the transferee's last name is not a value that can be modified. The attempt may then be ignored and a message may be outputted to notify the user that he or she cannot go back to that webpage. Further, each webpage may present an option to cancel the transaction. In one embodiment, a canceled transaction may be marked as a lost sale on a record associated with the transaction.

At operation 502, a request may be received to begin a new firearm transaction, such as a sale or other transfer of a new or used firearm. For example, FAST application module 122 may receive a request from a client device operated by a sales associate at a FFL store to initiate a new transaction and to generate a record for the transaction. In one embodiment, no new transactions may be initiated until all previous transactions are complete. A FFL may have such a policy to prevent errors or duplication in recording sales. Thus, in the embodiment, module 122 or another module may reject the request from the client device unless all previous transactions being conducted on the client device are complete or all previous transactions being conducted by the logged-in user on one or more client devices are complete.

At operation 504, a selection may be received for whether one or more firearms in the transaction is new. A transaction serial number used to identify the firearm transaction may be based on whether the one or more firearms are new or used. For example, sequential serial numbers may be assigned to only sales of new firearms.

At operation 506, a residency status of a customer or other transferee of the transaction may be received. In one embodiment, the operation may include outputting a list of possible residency statuses to be presented to the customer or to a FFL personnel. In one embodiment, possible residency statuses include a customer who is an active duty military member, an immigrant alien, a non-immigrant alien, or a standard state or local resident such as a non-military U.S. citizen. The transferee's residency status may affect one or more criteria that he or she needs to fulfill for the transaction.

At operation 507, a name of a customer or other transferee of the transaction may be received. In one embodiment, the received name may be verified to ensure that it contains only alphanumeric characters, spaces, and hyphens. Once a transferee name is received, a permanent transaction record may be created. In one embodiment, receipt of only a last name may be sufficient to create a permanent transaction record.

In operation 507 and all other operations, information such as a customer's name, phone number, and social security number may be encrypted before it is stored. For example, FAST application module 122 may encrypt a received customer name before storing it to database 140. In one embodiment, any time information is encrypted, it may be immediately decrypted to test an accuracy of the encryption and decryption. If a decrypted result does not match the received customer name, module 122 may throw an exception to indicate that the encryption and decryption may be inaccurate. If encryption and/or decryption are determined to be inaccurate, they may be disabled for method 500.

At operation 508, a confirmation may be received for creation of a permanent transaction record. Upon receiving the confirmation, a permanent record is created at operation 510. The permanent record may be added to a database table, and it may be assigned a transaction serial number based on whether the firearm is new or used. For example, FAST application module 122 may receive a click event from a browser of a client device, and the click event may indicate confirmation to create a permanent record. Module 122 may then cause FAST database 140 to create a new, permanent form 4473 record and to add the record to a Form 4473 database table. If the transaction has to be abandoned because, for example, a transferee is disqualified from the transaction, module 122 may mark its permanent record as a lost sale.

Once the permanent record is created, additional transaction information may be collected. As discussed above, the information may be received through one or more forms presented on one or more webpages of a web browser of a client device. In one embodiment, form information from a web page may be checked for completion. If one or more fields are missing, an indication of missing information may be outputted. In one embodiment, a webpage being presently completed may be tracked. If the client device or module 122 needs to recover from an error, for example, the tracked webpage may be loaded so as to resume the transaction where it likely last left off.

At operation 512, information on a current residence of a customer or other transferee of the firearm transaction is received. In one embodiment, operation 512 may include soliciting a selection of whether the customer is an active duty military personnel may received. If the received selection indicates that the customer is an active duty military personnel, one or more lists of states, counties, and/or cities having a permanent duty station may be generated and outputted to the client device. Other form fields may be generated and presented on the client device to allow a customer to enter local addresses (e.g., city name, street address, or zip code of a permanent duty station) not presented on the one or more lists. Entered local addresses, such as a zip code entry, received from the client device may be checked against a list of all valid zip codes stored on, for example, database 140. Once a permanent duty station address of a customer who is an active duty military personnel is received, a selection of whether the customer lives on base may be received. If the customer lives on base, the received permanent duty station address is recorded as his or her current residence address. If the customer does not live on base, he or she may be able to enter an address in a manner like a non-active-duty-military-personnel. For example, one or more lists of all states, counties, anchor cities in the United States or in any other country may be outputted for the FFL personnel or customer. Other form fields may be outputted to allow a customer to enter local addresses (e.g., city name, street address, or zip code) not presented on the one or more lists. In one embodiment, the information on the current residence may be received by FAST application module 122, stored in FAST database 140, and used to complete field 2 of a form 4473.

At operation 514, information on a place of birth of a customer or other firearm transferee is received. Operation 514 may include receiving a selection from a client device of whether the customer was born in the United States or in a foreign country. If the customer was born in a foreign country, a list of all foreign countries that are recognized by a government agency or that satisfy another criterion may be outputted. If the customer was born in the United States, one or more lists of all states, counties, and/or cities in the United States may be outputted. Form fields may also be outputted to allow a customer to enter a city, county, or state not appearing on the one or more lists. In one embodiment, the information may be received by module 122, stored in database 140, and used to complete field 3 of a form 4473.

At operation 516, information on a height and weight of a customer or other firearm transferee is received. In one embodiment, a bounds check may be performed on the received information. For example, received height may be checked for whether it is between 4 feet and 8 feet 11 inches, and received weight may be checked for whether it is between 50 pounds and 700 pounds. In one embodiment, the information may be received by module 122, stored in database 140, and used to complete fields 4 and 5 of a form 4473.

At operation 518, information on a gender of the transferee is received. In one embodiment, the information may be received by module 122, stored in database 140, and used to complete field 6 of a form 4473.

At operation 519, information on a transferee's birth date is received. Operation 519 may include outputting a calendar to the client device for presentation to the customer, who may select his or her birth date from the calendar. The received birth date may be used to determine the customer's age. In one embodiment, the customer's age and state of residence may be used to determine whether the customer is permitted to purchase certain types of firearm. For example, state law information from a database may indicate that customers under 18 cannot purchase any firearm and that customers under 21 cannot purchase a handgun. In one embodiment, the birth date information may be received by module 122, stored in database 140, and used to complete field 7 of a form 4473.

At operation 520, information on a social security number and unique personal identification number (UPIN) of a transferee may be received. In one embodiment, a received social security number may be checked to verify that it has 9 digits and a received UPIN may be checked to verify that it starts with the letter “V.” In one embodiment, the social security number and UPIN may be received by module 122, stored in database 140, and used to complete field 9 of a form 4473. In one embodiment, the social security number and/or UPIN may be encrypted before it is stored.

At operation 522, information on an ethnicity of a transferee may be received. Operation 522 may include outputting a list of ethnicities that are recognized by a government agency or that satisfy some other criterion. In one embodiment, the information may be received by module 122, stored in database 140, and used to complete field 10 of a form 4473.

At operation 524, a questionnaire may be outputted and responses to the questionnaire may be received. In one embodiment, the questionnaire may correspond to questions on field 11 of a form 4473, which includes whether the customer is acquiring the firearm on behalf of another person, a question regarding any legal indictment or conviction of the customer, a question regarding the mental health of the customer, and a question regarding citizenship of the customer. In one embodiment, a set of questions generated for a transferee who is a non-immigrant alien and a set of questions generated for a transferee who is not a non-immigrant alien may be different.

At operation 526, verification of a state of residence of a transferee is received. The verification may repeat a selection made by the transferee at operation 512, in which information on the transferee's current residence is received. In one embodiment, a list of states be outputted to the client device for selection by the customer or other transferee. The list of states may include all states in the United States or may include only states to which state law permits a transfer of firearm. For example, FAST application module 122 may determine from login information submitted at operation 202 a state in which the client device or its FFL store is located. Module 122 may retrieve from database 140 a list of states to which the FFL store can sell firearm. The list may be the one edited by a manager user at operations 408 and 416. Receiving a repeat selection from the transferee of his or her state of residence may act as a certification from the transferee that he or she resides in a state to which the FFL store is authorized to transfer firearm. If at operation 512 or 526 the received state of residence is not a state to which the FFL store may transfer a firearm, the transaction may be abandoned and the record associated with the transaction may be marked as a lost sale. Operation 526 may check the received state of residence to verify that it matches what the state of residence received at operation 512.

At operation 527, information on a citizenship of the transferee may be received. Operation 527 may include outputting one or more forms that collect information on whether the transferee is a United States citizen and whether the customer is a citizen of any other country. If a selection indicating the transferee is not a U.S. citizen is received, one or more forms that collect an alien registration number may be outputted for the transferee for his or her entry.

At operation 528, some or all information collected at operations 502-527 may be outputted to the client device and presented on the device as one or more review pages. Operation 528 may include receiving one or more indications from the client device that some or all information collected at operations 502-527 needs a correction. One or more forms may be outputted to the client device, which may present the forms to the transferee to enter a correction.

After an indication is received that all collected information is correct or has been corrected, a certification message may be transmitted to the client device at operation 528. In one embodiment, the certification message may ask whether all responses given for the firearm transaction is true, correct, and complete, and may indicate that a false response is a crime. A response of “Yes” or “No” may be received at operation 528 as a response to the certification message.

At operation 534, a list of one or more types of firearm may be outputted for presentation to a user. In one embodiment, operation 534 may include in the list all types of firearm in the FFL's inventory, but may indicate certain firearm types in the list to be restricted based on a state in which the FFL store is located or based on the transferee's residence or age. For example, operation 534 may include determining that a handgun cannot be sold to the transferee because he or she is under 21 years old. An indication that a particular type of firearm cannot be transferred may be transmitted to the client device along with the list of firearm types. In one embodiment, operation 534 may include checking whether the transferee's age or state of residence precludes all transfers of firearm to him or her. In the embodiment, operation 534 may cause the transaction to be abandoned and may mark the record associated with the transaction as a lost sale.

In one embodiment, operation 534 may occur after operation 528, and may be intended to transmit information for presentation to a store personnel rather than to a customer. For example, operation 534 may include generating a login page that is transmitted to the client device and receiving login information from the store personnel.

At operation 536, whether any responses collected for the firearm transaction disqualifies the transferee or otherwise prohibits the transaction is determined. For example, operation 536 may determine whether the transaction is prohibited based on the responses to the questionnaire received at operation 524, on the transferee's age, or on the transferee's residence and the FFL store's location.

If it is determined that the transferee is disqualified or that the transaction is otherwise prohibited, a disqualification message may be generated and sent to the client device at operation 537. The client device may then present the message to the store personnel or the transferee. Operation 537 may further include abandoning the prohibited transaction and marking the record associated with the transaction as a lost sale.

If it is determined that the transferee is not disqualified and that the transaction is not otherwise prohibited, whether a special permit for the transaction is required may be determined at operation 538. A permit may be required based on, for example, a type of firearm in the transaction, the transferee's residence, or the transferee's age. Operation 538 may include outputting a message asking whether the transferee has a required permit and receiving the transferee's response. In one embodiment, if the received response indicates that the transferee does not have a required permit, method 500 may return to operation 534 to select a different type or types of firearm being transferred. Transfer of the different type or types of firearm may require no special permits.

If an indication is received that the transferee does have a required special permit, information relating to the permit, such as identification information, may be received at operation 540. The identification information may include, for example, a driver license number, a military ID number, an issuance date, and an expiration date. In one embodiment, operation 540 may include generating a list of acceptable types of identification and receiving a selection of one of the types of acceptable identification associated with the identification information. The list may be the one viewed or edited at operations 410 and 416. In one embodiment, identification information and identification type may be received by module 122 and stored in database 140, and is used to complete field 20a of a form 4473.

At operation 542, alternate documentation information is received. The alternate documentation information may be used, for example, as a special permit required in a transaction. In one embodiment, operation 542 may include receiving a type of alternate documentation. Alternate documentation types may include, for example, a hunting or fishing license, a motor vehicle registration, or a state ID that is not used as a primary ID. In one embodiment, the alternate documentation information may be received by module 122, stored in database 140, and used to complete field 20b of a form 4473.

If the transferee was not born in the United States, information on his or her 90-day residency documentation may be received at operation 546. The information may include a type of the 90-day residency documentation used and dates of residency shown on the 90-day residency documentation. In one embodiment, the documentation information may be received by module 122, stored in database 140, and used to complete field 20c of a form 4473.

If the transferee is a non-immigrant alien, information on documentation showing an exception to a nonimmigrant alien prohibition may be received at operation 548. A nonimmigrant alien prohibition may arise, for example, when laws or other regulations may prohibit nonimmigrant aliens such as travelers, students who maintain a residence abroad, and certain foreign workers from purchasing a firearm in a state or country without an exception. Information on such an exception may include a type of documentation used to show the exception. In one embodiment, the types of acceptable documentation showing an exception to the nonimmigrant alien prohibition may include only a state hunting license and a letter of waiver from a U.S. attorney general. If the type of documentation received is a hunting license, a state that issued the hunting license may be collected.

At operation 550, a serial number for each of one or more firearm being transferred may be received. At operation 552, firearm information for each of the one or more firearm may be retrieved based on the firearm's serial number. For example, the firearm information can include the firearm's stock keeping unit (SKU) number, manufacturer and/or importer, caliber or gauge, firearm type, firearm model, and a log number.

At operation 554, whether multiple handguns will have been transferred to the transferee within a certain period of time, such as five days, may be determined. Operation 554 may include retrieving from a database, such as database 140, past firearm transactions associated with the transferee.

If it is determined that multiple handguns will have been transferred to the transferee within the last five days, a report of such multiple transfers may be generated. For example, at operation 556, a complete Report of Multiple Sale or Other Disposition of Pistols and Revolvers form, a template of which is provided by the Bureau of Alcohol, Tobacco, and Firearm (ATF), may be generated. In one embodiment, operation 556 may include generating the form in a PDF format, and may be performed by PDF Web Service module 127 or any other module.

At operation 558, the total number of firearm that being transferred to the transferee in the transaction is determined. In one embodiment, operation 558 may calculate a total number of firearm for which a serial number was received at operation 550. In one embodiment, the total number of transferred firearm may be determined by module 122, stored in database 140, and used to complete field 30a of a form 4473.

At operation 560, a phone number of the transferee is received. In one embodiment, the operation may include outputting a message asking for the transferee's phone number. In one embodiment, the operation may include parsing a received phone number into an area code, a three-digit portion of a local number, and a four-digit portion of the local number. In one embodiment, the phone number may be encrypted before being stored.

At operation 562, a point-of-sale (POS) register's transaction number is received.

At operation 564, a message may be outputted asking whether an associate or another sales personnel conducting the transaction is comfortable with the transaction. The message may be displayed, for example, on a browser of the client device, and a response to the message may be received from the client device's browser. If the received response indicates that the associate is not comfortable with the transaction, the transaction may be abandoned and the record associated with the transaction may be marked as abandoned at operation 566. If the received response indicates that the associate is comfortable with the transaction, a response from an electronic background check system may be obtained for the transaction. For example, operations of method 600, discussed below, may obtain a response from an electronic background check system.

At operation 570, a PDF version of a form 4473 associated with the transaction is generated, such as by PDF web service module 127. The PDF version may be outputted to the client device, which may present the PDF version to store personnel, to the transferee, or to another user.

At operation 572, a print job confirmation message is outputted. Operation 572 may include transmitting the print job confirmation message to the client device, which will present the message to a user. In one example, the print job confirmation message may instruct the user to verify that the PDF version of the form 4473 printed properly and that a transaction serial number on the printed form matches a transaction serial number presented on the client device. At operation 574, a print confirmation is received from the user. For example, a value of “Printed” or “Not Printed” may be received.

At operation 576, an additional requirements message is outputted. The message may relate to, for example, a waiting period requirement, a permit copy requirement, or any other additional requirement for the transaction. The message may be transmitted to the client device, which may present the message for the user.

At operation 578, a store personnel or other user is logged out of a current session. For example, at operation 578, FAST application module 122 may log out of a current session that a sales associate initiated on a browser of his or her client device.

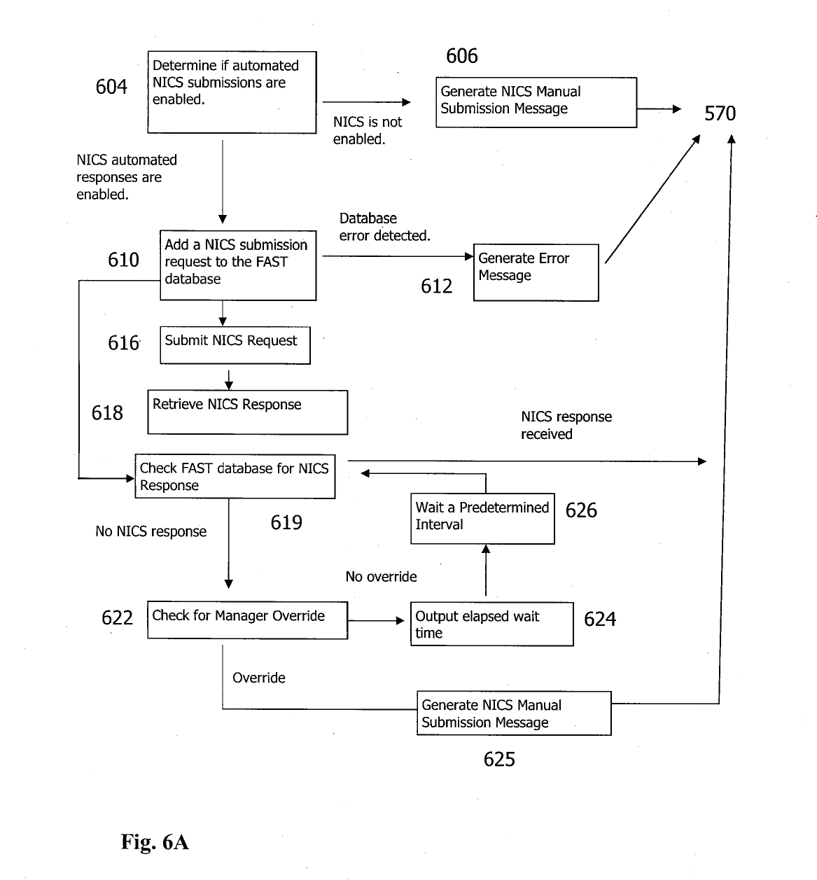

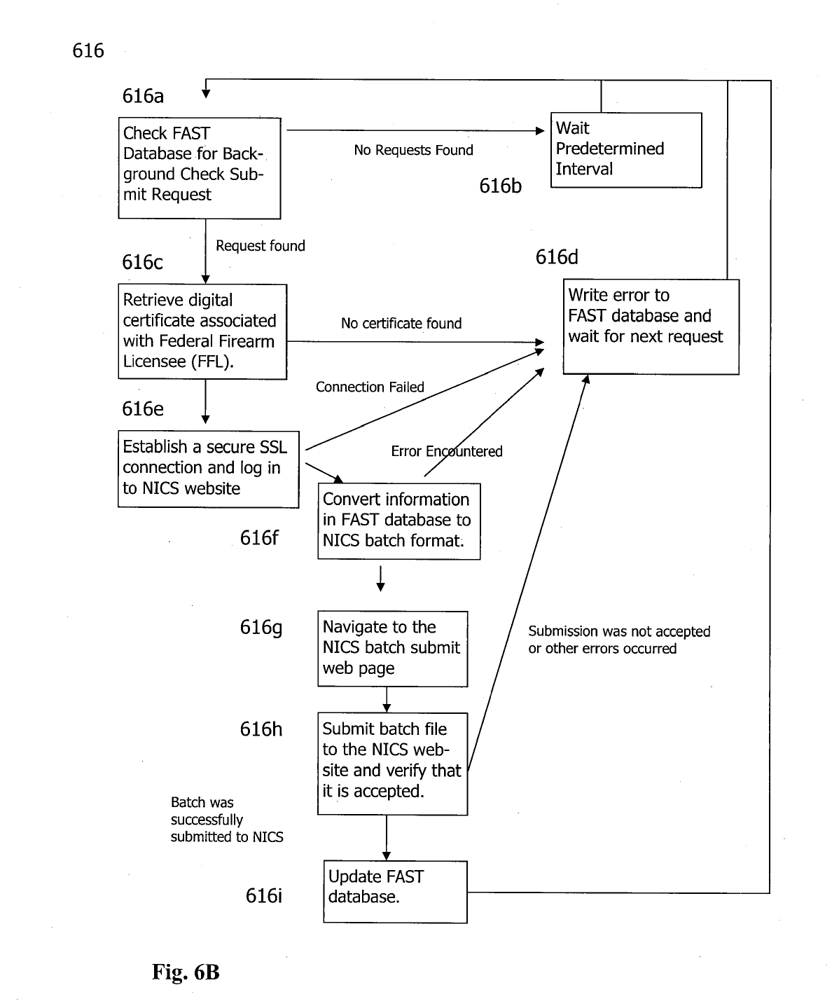

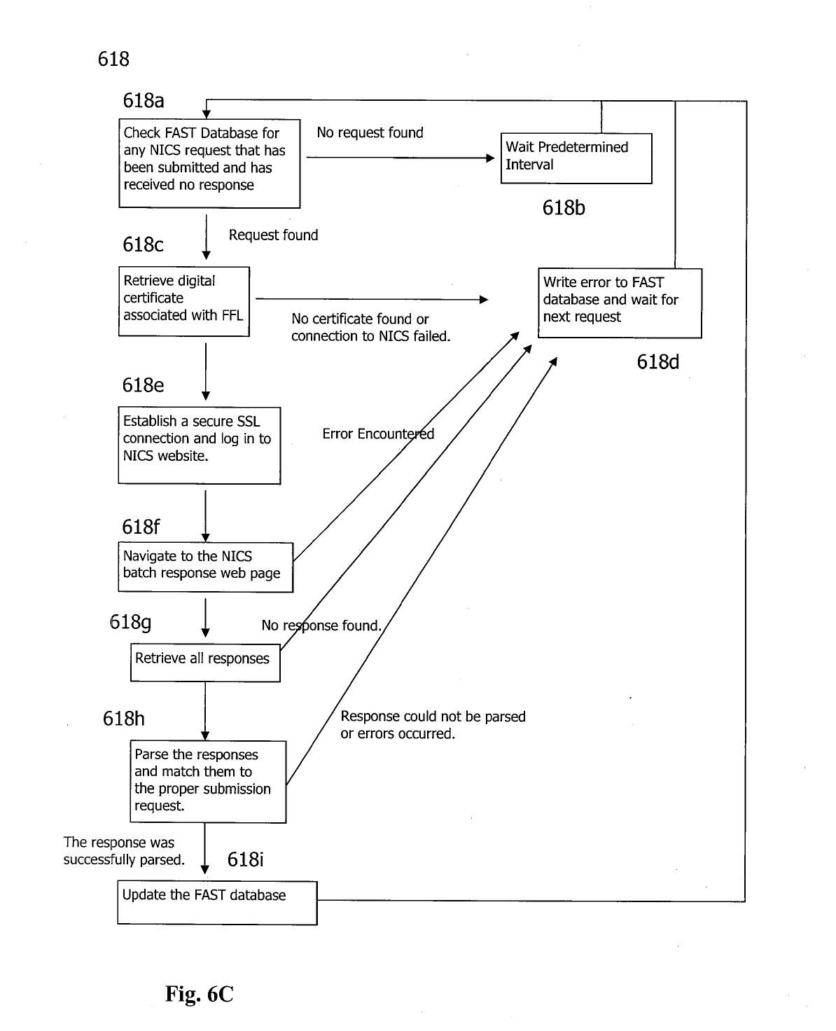

FIGS. 6A-6C show example operations of method 600. Method 600, as discussed above, can be used to obtain a background check for a firearm transaction. In the embodiments shown in FIGS. 6A-6C, a background check from the National Instant Criminal Background Check System (NICS) may be obtained. A response obtained from NICS may be stored in FAST database 140 and may be used to complete field 21c-e of a form 4473. In other embodiments, a response may be obtained from another electronic background check system.

At operation 604, whether automated NICS submission is enabled may be determined. In one embodiment, operation 604 may include retrieving from FAST database 140 a value indicating whether there is a NICS website that is accepting automated batch submissions. The value may be set by, for example, a direct communication from the NICS website, a direct command from FAST application module 122, or a direct command from a user of system 100.

If automated NICS submission is not enabled, a NICS manual submission message may be outputted at operation 606. In one embodiment, the message may indicate that a background check, such as one from NICS, must be obtained manually. The message may further indicate a phone number to call as part of a manual background check request. The message may be transmitted to a client device, which will present the message to a user. After the message is outputted at operation 606, a form 4473 not having a NICS response may be printed at operation 570.

If automated NICS submission is determined to be enabled, a background check request, such as a NICS submission request, is made at operation 610. Operation 610 may include recording the background check request in a database such as FAST database 140. For example, a firearm transaction record stored in database 140 may be marked as needing a submission to NICS. At operations 616 and 618, which are discussed below in more detail, background check request may be submitted to a NICS website and a response to the request may be retrieved from the NICS website. FAST database 140 may subsequently be checked at operation 619 for a response to the submitted request. If FAST database contains a NICS response at operation 619, the response may be used at operation 570 to generate a PDF version of a form 4473 for the firearm transaction.

If no NICS response is found in FAST database 140 at operation 619, database 140 may be checked again for a response after a predetermined interval. For example, a total elapsed amount of time waiting for the response may be outputted at operation 624, and the predetermined amount of time may be waited for at operation 626. The waiting may be terminated at operation 622 by a manager override. For example, at operation 622 input from a client device may be polled to determine whether the input contains a manager override command. If no manager override command has been received, the wait for a NICS response in FAST database 140 may continue. If a manager override command has been received, the wait may be terminated and a NICS manual submission message may be generated at operation 625. The NICS manual submission message may indicate that a background check, such as one from NICS, must be obtained manually. The message may further indicate a phone number of a mailing address to which the manual background check request can be submitted. The message may be outputted to a client device, which will present the message to a user. After the message is outputted at operation 625, a form 4473 not having a NICS response may be printed at operation 570.

FIG. 6B show example operations for submitting a NICS request. The operations may be sub-operations of operation 616. In one example, the sub-operations of operation 616 may be performed by NICS submit module 124. At operation 616a, FAST database 140 may be checked for a background check request. The background check request may have been added to database 140 at, for example, operation 610 discussed above. In one embodiment, the background check request may be detected by searching all pending firearm transaction records in database 140 for a record that has not yet submitted a request to NICS for a background check. In one embodiment, database 140 may be checked to detect multiple background check requests.

If no background check request is found, a predetermined amount of time may be waited for at operation 616b. After the predetermined interval elapses, FAST database 140 may be checked again for a background check request.

If one or more background check requests are found, they are submitted to NICS. A submission may involve a certificate and a secure connection. At operation 616c, a digital certificate associated with the store's FFL is retrieved. In one example, NICS submit module 124 may retrieve the digital certificate from database 140. If no certificate is found, an error may be logged in FAST database 140 at operation 616d. Failure to find the certificate may be logged as a general error or as a specific (e.g., certificate-related) error.

If a digital certificate is found, a secure connection, such as a SSL connection, with NICS is attempted at operation 616e. The secure connection may be with a NICS website. In one embodiment, attempting to establish the secure connection may include logging in to the NICS website, such as through a virtual browser. If the secure connection attempt fails, an error may be logged in FAST database 140 at operation 616d. The failed connection attempt may be logged as a general error or as a specific (e.g., connection-related) error.

If a secure connection is established with NICS, information associated with one or more background check requests can be submitted to NICS. The information may be stored in FAST database 140, and may be converted to a batch format at operation 616f. The batch format may be a format that NICS accepts to receive multiple requests during one transmission to NICS.

At operation 616g, a single background check request or a batch of requests may be transmitted to NICS by navigating to a NICS batch submit webpage. For example, NICS submit module 124 may transmit an Ajax-based request to a NICS web server to access information from a NICS batch submit webpage.

At operation 616h, a batch file of one or more background check requests are submitted to NICS. In one embodiment, the batch file may be submitted to a NICS web server. Operation 616h may further include verifying that the batch file has been accepted. For example, NICS submit module 124 may send a communication to the NICS web server asking for verification that the batch file has been received and accepted by the NICS web server. If the batch file submission was not received, not accepted, or experienced some other error, the error may be logged in FAST database 140 at operation 616d. The error may be logged as a general error or a specific (e.g., submission-related) error.

If the batch file submission was received and accepted, FAST database may be updated at operation 616i. For example, NICS submission module 124 may update all firearm transaction records whose requests have been submitted to indicate the successful transmission. In one embodiment, NICS submission module 124 may further write a date of submission or an identifying number to the transaction record. The information may be used to complete fields 21a and 21b of a form 4473.

FIG. 6C shows example operations for retrieving from NICS a response to the submitted background check requests. The example operations may be sub-operations of operation 618. In one embodiment, the sub-operations may be performed by NICS retrieve module 126.

At operation 618a, FAST database 140 may be checked to determine whether any submitted background check request is waiting a response. FAST database 140 may have been updated with information relating to the request at operation 616i. A submitted request may be waiting for a response if it has received no previous response from NICS or if a previous response was not complete. For example, a NICS response may return a value of either “proceed,” “denied,” “cancelled,” or “delayed.” A value of “delayed” may not be complete, and may be followed up by a subsequent NICS response of either “proceed,” “denied,” or “cancelled.” Operation 618a may include checking FAST database 140 for a submitted request that has received a response of “delayed.” A number of days since the “delayed” response was received may be tracked. For example, if NICS retrieve module 126 receives a response of “delayed,” it may update FAST database 140 with a receipt date. When NICS retrieve module 126 checks NICS for a subsequent response, it may determine whether three business days has passed since the previous response of “delayed.” If three days has passed, module 126 may store in database 140 an indication that no resolution for the transaction was provided within three business days. The indication may be detected by FAST application module 122 and used to complete field 21d of a form 4473. It may further be used to output a message that the firearm transaction is not prohibited by a background check because the background check has failed to provide a resolution within three business days.

If no submitted request is found to be waiting for a response, a predetermined interval may be waited for at operation 618b before FAST database 140 is checked again.

In one embodiment, at operation 618c, a digital certificate associated with the store's FFL is retrieved. In one example, NICS retrieve module 126 may retrieve the digital certificate from database 140. If no certificate is found, an error may be logged in FAST database 140 at operation 618d. Failure to find the certificate may be logged as a general error or as a specific (e.g., certificate-related) error. If a digital certificate is found, a secure connection, such as a SSL connection, with NICS is attempted at operation 618e. The secure connection may be with a NICS website.

In one embodiment, attempting to establish the secure connection may include logging in to the NICS website. The login may be performed instead of or in addition to submitting a digital certificate. The login may include, for example, submitting a login name and a password to the NICS website. The login name and password may be encrypted before the submission.

If the secure connection attempt fails, an error may be logged in FAST database 140 at operation 618d. The failed connection attempt may be logged as a general error or as a specific (e.g., connection-related) error.

If a secure connection is established with NICS, information associated with a response to each of one or more background check requests can be retrieved from NICS. In one embodiment, a batch of multiple responses may be retrieved. At operation 618f, the batch may be retrieved by navigating to a NICS batch response web page. For example, NICS retrieve module 126 may transmit an Ajax-based request to a NICS web server to access information from a NICS batch response web page. If an error is encountered while navigating to the batch response web page, the error may be logged in FAST database 140 at operation 618d.

At operation 618g, one or more responses corresponding to one or more requests may be retrieved from NICS. The one or more responses may be retrieved as a single batch file, or may be retrieved in multiple batch files. In one embodiment, if no response is found, an error may be logged in FAST database 140. The error may be logged as a general error or as a specific (e.g., response-related) error.

After one or more responses are retrieved, the responses are parsed at operation 618h. In one embodiment, each of the one or more responses may be parsed to determine a firearm transaction serial number associated with the response and a background check result (e.g., a result of proceed, denied, cancelled, or delayed). Error checking may be performed on a parsed value. For example, a parsed transaction serial number may be checked for whether it falls within a predetermined, valid range. If the response is not able to be parsed or the parsed value is determined to have an error, a logged entry may be written in FAST database 140 to indicate a general error or a specific (e.g., parse-related) error. If the response is determined to be successfully parsed, FAST database can be updated at operation 618i.

Example sizes/models/values/ranges may have been given, although embodiments of the present invention are not limited to the same. Arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A method for complying with a firearm transfer regulation, comprising:
determining, from a database containing information related to a firearm transfer, whether the firearm transfer needs a response from an electronic background check system;
querying the electronic background check system for the response;
receiving the response from the electronic background check system; and
generating a command to update the database with the received response.

2. The method of claim 1, wherein querying the electronic background check system comprises communicating with a website server of the electronic background check system.

3. The method of claim 2, wherein the website server of the electronic background check system is a National Instant Criminal Background Check System website server.

4. The method of claim 1, wherein the electronic background check system comprises a background check database.

5. The method of claim 1, further comprising communicating, subsequent to determining that the firearm transfer needs the response from the electronic background check system and prior to querying the electronic background check system, at least part of the contained information related to the firearm transfer to the electronic background check system.

6. The method of claim 5, wherein communicating the at least part of the information of the firearm transfer comprises communicating information relating to a transferee of the firearm transfer.

7. The method of claim 5, further comprising:
establishing a first secure connection with the electronic background check system prior to the communicating the at least part of the information related to the firearm transfer;
terminating the first secure connection subsequent to communicating the at least part of the information related to the firearm transfer; and
establishing a second secure connection with the electronic background check system prior to querying to the electronic background check system for the response.

8. The method of claim 1, wherein the response is a first response, the method further comprising querying the electronic background check system for a second response if the first response indicates a delayed background check decision.

9. The method of claim 1, further comprising generating a document related to the firearm transfer, the document including the received response.

10. A method for complying with a firearm transfer regulation, comprising:
determining, from a database containing information related to a firearm transfer, whether the contained information related to the firearm transfer is complete for a background check, and
communicating at least part of the information related to the firearm transfer to an electronic background check system containing background check information if the contained information related to the firearm transfer is complete, the at least part of the information including information related to a transferee of the firearm transfer.

11. The method of claim 10, further comprising determining, prior to communicating the at least part of the information to the electronic background check system, whether the firearm transfer needs a response from the electronic background check system.

12. The method of claim 10, further comprising generating a command to update the database with an indication that the at least part of the information has been communicated to the electronic background check system.

13. The method of claim 10, further comprising
establishing a secure connection with the electronic background check system prior to communicating the at least part of the information related to the firearm transfer; and
terminating the secure connection subsequent to communicating the at least part of the information related to the firearm transfer.

14. A non-transitory computer-readable medium having one or more instructions thereon, the one or more instructions, when executed by one or more processors, causing the one or more processors to:
determine, from a database containing information related to a firearm transfer, whether the firearm transfer needs a response from an electronic background check system containing background check information,
query the electronic background check system for the response,
receive the response from the second electronic background check system, and
generate a command to update the database with the received response.

15. The non-transitory computer-readable medium of claim 15, wherein the one or more instructions further cause the one or more processors to query the electronic background check system by communicating with a website server of the electronic background check system.

16. The non-transitory computer-readable medium of claim 15, wherein the website server of the electronic background check system is a National Instant Criminal Background Check System website server.

17. The non-transitory computer-readable medium of claim 15, wherein the one or more instructions further cause the one or more processors to communicate, subsequent to determining that the firearm transfer needs the response from the electronic background check system and prior to querying the electronic background check system for the response, at least part of the contained information related to the firearm transfer to the electronic background check system.

18. The non-transitory computer-readable medium of claim 17, wherein the one or more instructions cause the one or more processors to communicate the at least part of the information of the firearm transfer by communicating information relating to a transferee of the firearm transfer.

19. The non-transitory computer-readable medium of claim 16, wherein the one or more instructions further cause the one or more processors to:
establish a first secure connection with the second electronic background check system prior to submitting the at least part of the information related to the firearm transfer;
terminate the secure connection subsequent to submitting the at least part of the information related to the firearm transfer; and
establish a second secure connection with the electronic background check system prior to querying to the electronic background check system for the response.

20. The non-transitory computer-readable medium of claim 14, wherein the one or more instructions further cause the one or more processors to generate a document related to the firearm transfer, the document including the received response.

21. A non-transitory computer-readable medium having one or more instructions thereon, the one or more instructions, when executed by one or more processors, causing the one or more processors to:
determine, from a database containing information related to a firearm transfer, whether the contained information related to the firearm transfer is complete for a background check, and
communicate at least part of the information related to the firearm transfer to an electronic background check system if the contained information related to the firearm transfer is complete, the at least part of the information including information related to a transferee of the firearm transfer.

22. The non-transitory computer-readable medium of claim 21, wherein the one or more instructions further cause the one or more processors to determine, prior to communicating the at least part of the information to the electronic background check system, whether the firearm transfer needs a response from the electronic background check system.

23. The non-transitory computer-readable medium of claim 21, wherein the one or more instructions further cause the one or more processors to generate a command to update the database with an indication that the at least part of the information has been communicated to the electronic background check system.

24. The non-transitory computer-readable medium of claim 21, wherein the one or more instructions further cause the one or more processors to:
establish a secure connection with the electronic background check system prior to submitting the at least part of the information related to the firearm transfer, and
terminate the secure connection subsequent to submitting the at least part of the information related to the firearm transfer.
